(19) United States
(12) Patent Application Publication
(10) Pub. No.: US 2014/0049774 A1
(43) Pub. Date: Feb. 20, 2014

(54) DEW CONDENSATION DETECTION METHOD AND DEVICE

(71) Applicant: FUJIFILM Corporation, Tokyo (JP)

(72) Inventors: Kazuyoshi HORII, Ashigarakami-gun (JP); Masashi HAKAMATA, Ashigarakami-gun (JP)

(73) Assignee: FUJIFILM Corporation, Tokyo (JP)

(21) Appl. No.: 14/040,083

(22) Filed: Sep. 27, 2013

Related U.S. Application Data
(63) Continuation of application No. PCT/JP2012/001910, filed on Mar. 21, 2012.

(30) Foreign Application Priority Data
Mar. 28, 2011 (JP) 2011-070008

(51) Int. Cl. G01N 21/94

(52) U.S. Cl. CPC G01N 21/94
USPC 356/237.3

(57) ABSTRACT

A dew condensation detection device includes: a light emitting unit for emitting a light flux that travels along a dew condensation detection surface of a member having the dew condensation detection surface; a changing unit for changing a diameter of the light flux; and an optical detector for receiving the light flux that has passed along the dew condensation detection surface.

### BACKGROUND OF THE INVENTION

1. Field of the Invention

The present invention relates to a method for detecting the occurrence and the level of dew condensation on a given member.

The present invention also relates to a device for carrying out the dew condensation detection method.

2. Description of the Related Art

With respect to devices for performing measurement or analysis of a biologically derived substance or a chemical substance using an analysis chip, for example, dew condensation on the analysis chip, or the like, may result in an incorrect measurement or analysis. Therefore, for this type of devices, it is desired to detect the occurrence and/or the level of dew condensation in an atmosphere in which the analysis chip, or the like, is placed.

More particularly, in a case where the measurement or analysis is performed by using an immune reaction, enzyme reaction, or the like, on a micro analysis chip having a micro channel, for example, the reaction is highly temperature dependent, and therefore temperature control for accurately controlling the temperature of the reaction area to a predetermined temperature is performed during a measurement for diagnosis, etc., requiring high reliability. The temperature control is achieved using a temperature control unit that performs heating and cooling. When cooling is performed under a high-temperature and high-humidity environment, there is a problem of the phenomenon of dew condensation on the surface of the temperature control unit due to moisture in the air. In particular, in a case where optical detection is performed after the reaction, water droplets due to the dew condensation absorb or scatter the detection light, and this influences the measured value. Therefore, there is a demand for accurately detecting the level of dew condensation.

Besides the above-described purpose, dew condensation or droplet deposition on the windshield of an automobile is detected to automatically start the wiper, for example.

As representative devices of prior art for detecting dew condensation or droplet deposition, those disclosed in Japanese Patent No. 4513681, Japanese Unexamined Patent Publication No. 59 (1984)-137844 and Japanese Examined Utility Model Publication No. 62(1987)-005642 (hereinafter, Patent Documents 1, 2 and 3, respectively) , for example, are known. For example, Patent Document 1 discloses a device wherein light is applied to the windshield of an automobile from a light source provided in the cabin, and the amount of total reflection of the light at the interface between the windshield and the air is monitored with an optical detector to detect dew condensation or droplet deposition on the windshield utilizing the fact that the amount of total reflection of the light decreases when dew condensation or droplet deposition occurs on the surface of the glass.

Patent Document 2 discloses a device wherein light is made to propagate through an optical fiber provided with portions where the circumferential surface of the core is exposed, and light exiting from the terminal end of the optical fiber is monitored to detect dew condensation or droplet deposition utilizing the fact that the amount of monitored light decreases due to propagation loss when dew condensation or droplet deposition occurs on the circumferential surface of the core.

Patent Document 3 discloses a device wherein light emitted from a light source is reflected on the surface of a mirror, and the amount of the reflected light is monitored with an optical detector to detect dew condensation or droplet deposition utilizing the fact that the amount of reflected light decreases when dew condensation or droplet deposition occurs on the surface of the mirror.

### SUMMARY OF THE INVENTION

With respect to the above-described devices for performing measurement or analysis, tolerance for dew condensation varies depending not only on the required accuracy of measurement but also on the optical system used. For example, comparing total reflection optical systems and incident light optical systems, the total reflection optical systems have higher sensitivity and are influenced by even a slight amount of dew condensation. On the other hand, the incident light optical systems have lower sensitivity and therefore have a higher tolerance for dew condensation. The tolerance for dew condensation also varies depending on the path of light applied to the detection area of a micro analysis chip. For example, if the path of the light is in the vicinity of an area where the analysis chip is in contact with the temperature control unit, the light is more subject to dew condensation on the temperature control unit. On the other hand, if the path of the light is in the vicinity of the surface on the opposite side from the area where the analysis chip is in contact with the temperature control unit, the light is less subject to the dew condensation.

As described above, the state of dew condensation to be detected largely varies depending on the accuracy of measurement, the optical system and the assumed environmental temperature and humidity. Required performances of the dew condensation detection under the above-described circumstances include freedom of changing a value of the minimum detectable amount of dew condensation, and high sensitivity for obtaining a large signal in a detectable range.

FIG. 5 shows a relationship between the amount of dew condensation (the level of dew condensation) on a dew condensation detection surface of each device disclosed in Patent Documents 1 to 3 and the amount of decrease of the corresponding light detection signal. The relationship with respect to the devices disclosed in Patent Documents 1 and 2 is basically one shown by the curve a. Namely, with this type of devices, the amount of total reflection of the light markedly decreases and the light detection signal largely decreases when dew condensation occurs on the surface of the windshield or the core, and therefore the occurrence of dew condensation is clearly detectable. However, since the light detection signal markedly decreases even with a small amount of dew condensation, it is difficult to adjust the value of the minimum detectable amount of dew condensation. Further, with these devices, although the light detection signal largely decreases when dew condensation is detected, the signal saturates soon and it is difficult to accurately detect the amount of dew condensation.

On the other hand, the relationship with respect to the device disclosed in Patent Document 3 is basically one shown by the curve b. Namely, with this type of devices, it is also difficult to adjust the value of the minimum detectable amount of dew condensation. Further, this type of devices typically have low sensitivity for the detection of dew condensation. One may consider increasing the sensitivity by increasing the spot size of light applied to the mirror. However, in this case, light intensity per unit area on the mirror decreases, and it is, after all, difficult to effectively increase the sensitivity.

In view of the above-described circumstances, the present invention is directed to providing a dew condensation detection method that allows adjusting the value of the minimum detectable amount of dew condensation, and allows highly sensitive detection of the level of dew condensation, i.e., the amount of dew condensation.

The present invention is also directed to providing a dew condensation detection device that carries out the above-described method.

A first aspect of the dew condensation detection method according to the invention includes: letting a light flux to travel along a dew condensation detection surface of a member having the dew condensation detection surface, wherein a diameter of the light flux is changeable; detecting an amount of light of the light flux that has passed along the dew condensation detection surface; and detecting a state of dew condensation on the dew condensation detection surface based on the detected amount of light.

The “dew condensation detection surface” herein refers to a surface that is possibly subject to dew condensation and is used for the dew condensation detection. The description “letting a light flux to travel along a dew condensation detection surface” refers not only to a case where the travel direction of the light flux is parallel to the direction in which the dew condensation detection surface extends, but also to a case where the light flux is angled to the direction in which the dew condensation detection surface extends (the same applies to the following aspects).

A second aspect of the dew condensation detection method according to the invention includes: letting a light flux to travel along a dew condensation detection surface of a member having the dew condensation detection surface, wherein the member and a light emitting unit are movable relative to one another to change a distance between the center of the light flux and the dew condensation detection surface; detecting an amount of light of the light flux that has passed along the dew condensation detection surface; and detecting a state of dew condensation on the dew condensation detection surface based on the detected amount of light.

A first aspect of the dew condensation detection device according to the invention is a device to carry out the above-described first aspect of the dew condensation detection method, and includes: a light emitting unit for emitting a light flux that travels along a dew condensation detection surface of a member having the dew condensation detection surface; a changing unit for changing a diameter of the light flux; and an optical detector for receiving the light flux that has passed along the dew condensation detection surface.

A second aspect of the dew condensation detection device according to the invention is a device to carry out the above-described second aspect of the dew condensation detection method, and includes: a light emitting unit for emitting a light flux that travels along a dew condensation detection surface of a member having the dew condensation detection surface; a moving unit for moving the member and the light emitting unit relative to one another to change a distance between the center of the light flux and the dew condensation detection surface; and an optical detector for receiving the light flux that has passed along the dew condensation detection surface.

In the second aspect of the dew condensation detection device, the member may include a pair of members having the dew condensation detection surface, the pair of members being disposed such that the light flux travels through between the dew condensation detection surfaces thereof, and the moving unit may move the pair of members in a direction in which a distance between the pair of members is changed.

In the second aspect of the dew condensation detection device, the member may include a tubular dew condensation detection surface that surrounds the light flux, and the moving unit may deform the member to change the inner diameter of the dew condensation detection surface.

In the second aspect of the dew condensation detection device, the member may include a plurality of tubular dew condensation detection surfaces that surround the light flux, the tubular dew condensation detection surfaces having different inner diameters, and the moving unit may move the member and the light emitting unit relative to one another in a direction along which the dew condensation detection surfaces are arranged so that the light flux selectively travels along one of the dew condensation detection surfaces.

It should be noted that the plurality of dew condensation detection surfaces of the member may have different lengths in a travel direction of the light flux.

In the first and second aspects of the dew condensation detection device according to the invention, the member may be formed to have a telescopic structure, for example, such that a length of the dew condensation detection surface in a travel direction of the light flux is changeable.

In the first aspect of the dew condensation detection method according to the invention, a light flux is let to travel along a dew condensation detection surface of a member having the dew condensation detection surface, wherein a diameter of the light flux is changeable, an amount of light of the light flux that has passed along the dew condensation detection surface is detected, and a state of dew condensation on the dew condensation detection surface is detected based on the detected amount of light. This allows highly sensitive detection of the occurrence of dew condensation utilizing the fact that part of the light flux is absorbed or scattered by dew condensation droplets and the detected amount of light decreases when dew condensation is occurring on the dew condensation detection surface. Further, since the decrease of the detected amount of light increases when the amount of dew condensation increases, the amount of dew condensation can be found based on the detected amount of light.

In the first aspect of the dew condensation detection method, the diameter of the light flux is changeable. When the diameter of the light flux is increased, the above-described absorption and scattering occurs with a smaller amount of dew condensation, and this allows setting a smaller value of the minimum detectable amount of dew condensation. On the other hand, when the diameter of the light flux is reduced, a larger amount of dew condensation is required to absorb or scatter the light flux, and this allows setting a greater value of the minimum detectable amount of dew condensation.

In the second aspect of the dew condensation detection method according to the invention, a light flux is let to travel along a dew condensation detection surface of a member having the dew condensation detection surface, wherein the member and a light emitting unit are movable relative to one another to change a distance between the center of the light flux and the dew condensation detection surface, an amount of light of the light flux that has passed along the dew condensation detection surface is detected, and a state of dew condensation on the dew condensation detection surface is detected based on the detected amount of light. This method also allows highly sensitive detection of the occurrence of dew condensation utilizing the fact that part of the light flux is absorbed or scattered by dew condensation droplets and the detected amount of light decreases when dew condensation is occurring on the dew condensation detection surface. Further, since the decrease of the detected amount of light increases when the amount of dew condensation increases, the amount of dew condensation can be found based on the detected amount of light.

In the second aspect of the dew condensation detection method, the member and the light emitting unit are movable relative to one another to change the distance between the center of the light flux and the dew condensation detection surface. When the distance is reduced, the above-described absorption and scattering occurs with a smaller amount of dew condensation, and this allows setting a smaller value of the minimum detectable amount of dew condensation. On the other hand, when the distance is increased, a larger amount of dew condensation is required to absorb or scatter the light flux, and this allows setting a greater value of the minimum detectable amount of dew condensation.

The first aspect of the dew condensation detection device according to the invention includes a light emitting unit for emitting a light flux that travels along a dew condensation detection surface of a member having the dew condensation detection surface, a changing unit for changing a diameter of the light flux, and an optical detector for receiving the light flux that has passed along the dew condensation detection surface, and is therefore capable of carrying out the above-described first aspect of the dew condensation detection method according to the invention.

The second aspect of the dew condensation detection device according to the invention includes a light emitting unit for emitting a light flux that travels along a dew condensation detection surface of a member having the dew condensation detection surface, a moving unit for moving the member and the light emitting unit relative to one another to change a distance between the center of the light flux and the dew condensation detection surface, and an optical detector for receiving the light flux that has passed along the dew condensation detection surface, and is therefore capable of carrying out the above-described second aspect of the dew condensation detection method according to the invention.

In the first and second aspects of the dew condensation detection device according to the invention, in the case where, in particular, the member is formed such that a length of the dew condensation detection surface in a travel direction of the light flux is changeable, the sensitivity of the dew condensation detection is also adjustable. Namely, under the condition where the level of dew condensation is the same, a longer length of the dew condensation detection surface means that the light flux is absorbed or scattered by a larger amount of dew condensation droplets, and this results in higher sensitivity of the dew condensation detection. On the other hand, a shorter length of the dew condensation detection surface means that the light flux is absorbed or scattered by a smaller amount of dew condensation droplets, and this results in lower sensitivity of the dew condensation detection.

### BRIEF DESCRIPTION OF THE DRAWINGS

FIG. 1 is a schematic perspective view illustrating a dew condensation detection device according to a first embodiment of the present invention,

FIG. 2 is a graph showing the light absorption coefficient of water for each wavelength,

FIG. 3 is a sectional view illustrating a structure in the vicinity of a dew condensation detection surface of the device shown in FIG. 1,

FIG. 4 is a sectional view illustrating a state where dew condensation occurs on the structure shown in FIG. 3,

FIG. 5 is a graph showing a basic relationship between the amount of dew condensation and the amount of decrease of a light detection signal with respect to the device shown in FIG. 1, together with the relationships with respect to conventional devices,

FIG. 6 is a sectional view illustrating a structure in the vicinity of a dew condensation detection surface of a dew condensation detection device according to a second embodiment of the invention,

FIG. 7 is a sectional view illustrating a structure in the vicinity of a dew condensation detection surface of a dew condensation detection device according to a third embodiment of the invention,

FIG. 8 is a sectional view illustrating a structure in the vicinity of a dew condensation detection surface of a dew condensation detection device according to a fourth embodiment of the invention,

FIG. 9 is a sectional view illustrating a state where dew condensation occurs on the structure shown in FIG. 8,

FIG. 10 is a sectional view illustrating a structure in the vicinity of a dew condensation detection surface of a dew condensation detection device according to a fifth embodiment of the invention,

FIG. 11 is a sectional view illustrating a structure in the vicinity of a dew condensation detection surface of a dew condensation detection device according to a sixth embodiment of the invention,

FIG. 12 is a sectional view illustrating a structure in the vicinity of a dew condensation detection surface of a dew condensation detection device according to a seventh embodiment of the invention,

FIG. 13 is a sectional view illustrating a structure in the vicinity of a dew condensation detection surface of a dew condensation detection device according to an eighth embodiment of the invention, and

FIG. 14 is a plan view illustrating a structure in the vicinity of a dew condensation detection surface of a dew condensation detection device according to a ninth embodiment of the invention.

### DESCRIPTION OF THE PREFERRED EMBODIMENTS

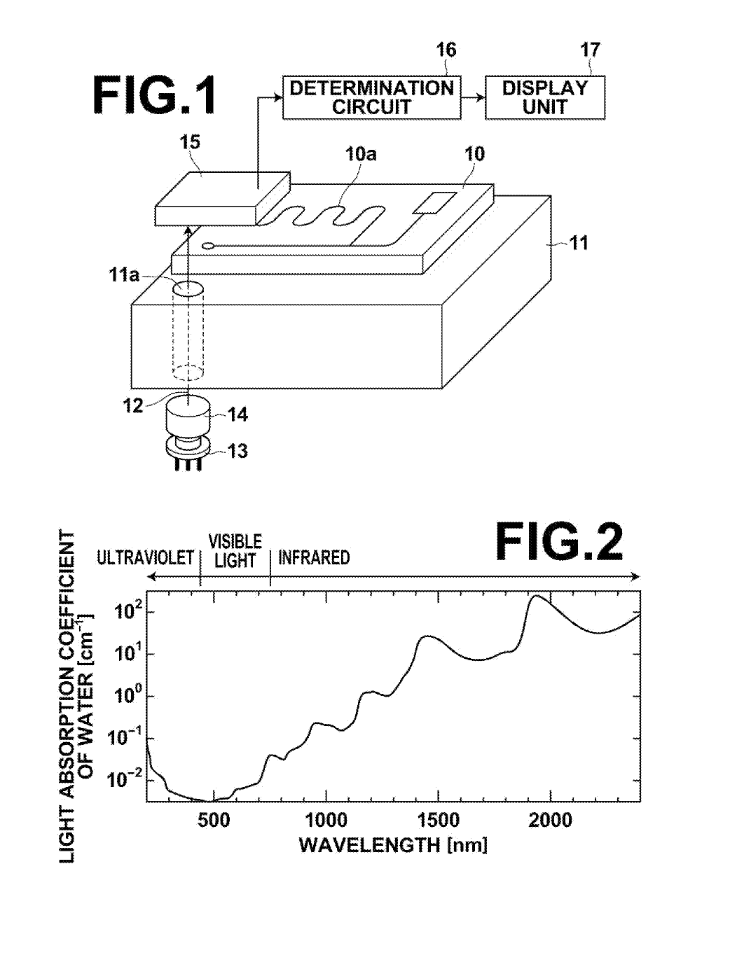

Hereinafter, embodiments of the present invention will be described in detail with reference to the drawings. FIG. 1 schematically shows a dew condensation detection device according to a first embodiment of the invention. As one example, the dew condensation detection device of this embodiment is applied to a device for analyzing a biologically derived substance, which uses a micro analysis chip 10 having a micro channel 10a to optically detect, for example, a change of the color of the reaction area of the micro analysis chip 10.

With this type of analysis device, the temperature of the micro analysis chip 10 is controlled to a predetermined temperature by a temperature control block 11 formed by an aluminum block, or the like, coupled to a Peltier device, for example. In particular, in a case where cooling is performed under a high-temperature and high-humidity environment, a phenomenon where moisture in the air condensates on the surface of the temperature control block 11 occurs. Then, water droplets due to the dew condensation absorbs or scatters the measurement light applied from an optical detection means (not shown), and this influences the measured value. Therefore, there is a demand for accurately detecting the state of dew condensation on the surface of the temperature control block 11.

The dew condensation detection device of this embodiment, which is provided to meet this demand, includes: a light source 13, such as a semiconductor laser, which emits light faulting a light flux 12; and an optical system 14, which includes a collimator lens for collimating the light emitted from the light source 13 in the form of diverging light into parallel light, a beam expander capable of adjusting the beam diameter of the parallel light, etc. That is, in this embodiment, the light source 13 and the optical system 14 forma light emitting unit that emits the light flux 12 in the form of parallel light.

It is desirable that the light flux 12 has a wavelength that is highly absorbable by water. FIG. 2 shows the absorption coefficient of water for each wavelength of light. As shown, the absorption coefficient of water for infrared light is greater than that for visible light. Therefore, a semiconductor laser that emits infrared light, for example, may be used as the light source 13.

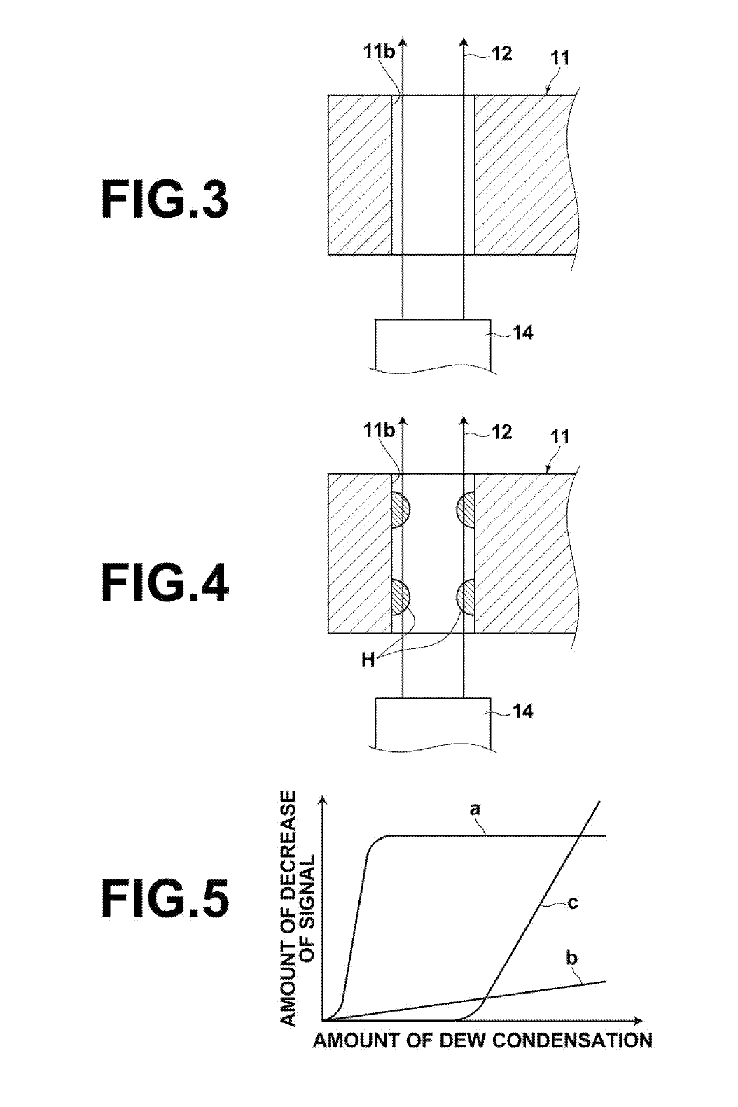

The temperature control block 11 is provided with a through hole 11a, through which the light flux 12 travels. FIGS. 3 and 4 show a cylindrical inner circumferential wall surface 11b of the through hole 11a. The inner circumferential wall surface 11b is possibly subject to dew condensation due to cooling of the temperature control block 11. Therefore, in this embodiment, this inner circumferential wall surface serves as a dew condensation detection surface 11b. The light source 13 and the optical system 14 are disposed such that the light flux 12 travels inside the through hole 11a in parallel with the through hole 11a, i.e., travels upward along the direction in which the dew condensation detection surface 11b extends.

An optical detector 15, which receives the light flux 12 that has passed through the through hole 11a, is disposed above the temperature control block 11. The optical detector 15 is formed, for example, by a CCD area sensor. In this embodiment, the optical detector 15 is also used to monitor the flow of a sample liquid in the micro channel 10a of the micro analysis chip 10. An output signal from the optical detector 15 is inputted to a determination circuit 16. Then, an output from the determination circuit 16 is inputted to a display unit 17, which is formed, for example, by a liquid crystal display device.

Now, operation of the dew condensation detection device of this embodiment having the above-described structure is described.

In this embodiment, dew condensation on the dew condensation detection surface 11b is detected to know the state of dew condensation on the surface of the temperature control block 11 on the assumption that the state of dew condensation on the cylindrical dew condensation detection surface lib is the same as the state of dew condensation on the surface of the temperature control block 11. Therefore, as shown in FIGS. 3 and 4, the light flux 12 that has passed through the through hole 11a along the dew condensation detection surface 11b is received by the optical detector 15 shown in FIG. 1, and an amount of the received light flux 12 is detected. FIG. 3 shows a state where no dew condensation occurs on the dew condensation detection surface lib. In this state, the amount of light detected by the optical detector 15 becomes a given maximum value. On the other hand, in the state of dew condensation, as shown in FIG. 4, where droplets H are deposited on the dew condensation detection surface 11b, the droplets H absorb or scatter the light flux 12, resulting in a decreased amount of light detected by the optical detector 15. The decrease of the amount of light is more marked when the amount of dew condensation is larger.

That is, as shown by the curve c in FIG. 5, the decrease of the value of a light detection signal outputted by the optical detector 15 is lager when the amount of dew condensation is lager. Further, since there is a slight space between the edge of the light flux 12 and the dew condensation detection surface 11b, the light detection signal does not immediately begin to decrease when a very small amount of dew condensation occurs on the dew condensation detection surface 11b. The light detection signal begins to decrease when the amount of dew condensation has reached a certain level. In this manner, the light detection signal that indicates a value depending on the amount of dew condensation is inputted to the determination circuit 16.

Based on the light detection signal, the determination circuit 16 sends a display signal that shows an amount of dew condensation according to the value of the signal to the display unit 17, and the display unit 17 displays the amount of dew condensation based on the display signal. The display of the amount of dew condensation may show the level of dew condensation in a stepwise fashion, or may show the amount of dew condensation per unit area in a continuous fashion. Correspondence between the amount of dew condensation per unit area and the value of the light detection signal outputted by the optical detector 15 can be found based on experiments.

Basically, the above-described decrease of the light detection signal is more marked when the amount of dew condensation is larger. Therefore, the signal does not saturate soon after the occurrence of dew condensation is detected, as in the case shown by the curve a in FIG. 5, and the amount of dew condensation can be detected over a wide range. Further, since the dew condensation droplets H, which cause the decrease of the light detection signal, may deposit on a long area along the travel direction of the light flux 12, the light detection signal markedly decreases when the level of dew condensation has slightly increased. This allows highly sensitive detection of the amount of dew condensation.

Further, the amount of dew condensation at which the light detection signal outputted by the optical detector 15 begins to decrease, i.e., the value of the minimum detectable amount of dew condensation, is smaller when the space between the edge of the light flux 12 and the dew condensation detection surface 11b is smaller. Therefore, a smaller value of the minimum detectable amount of dew condensation can be set by operating the beam expander included in the optical system 14 to increase the diameter of the light flux 12. Also, a greater value of the minimum detectable amount of dew condensation can be set by operating the beam expander included in the optical system 14 to decrease the diameter of the light flux 12. In other words, with respect to the characteristics shown in FIG. 5, a point on the curve c where the value begins to increase can be shifted in the horizontal direction of the graph.

The light detection signal outputted by the optical detector 15 is used to display whether or not dew condensation is occurring and the amount of dew condensation, as described above, and is also applicable to feedback control for temporarily warming the temperature control block 11 to remove dew condensation when the dew condensation is detected. In this case, it may be desired to avoid performing the feedback control when the level of dew condensation is quite low. In this embodiment, the value of the minimum detectable amount of dew condensation (i.e., the dead zone) can be arbitrarily set in the manner as described above, and therefore the above-described demand with respect to the feedback control can be met.

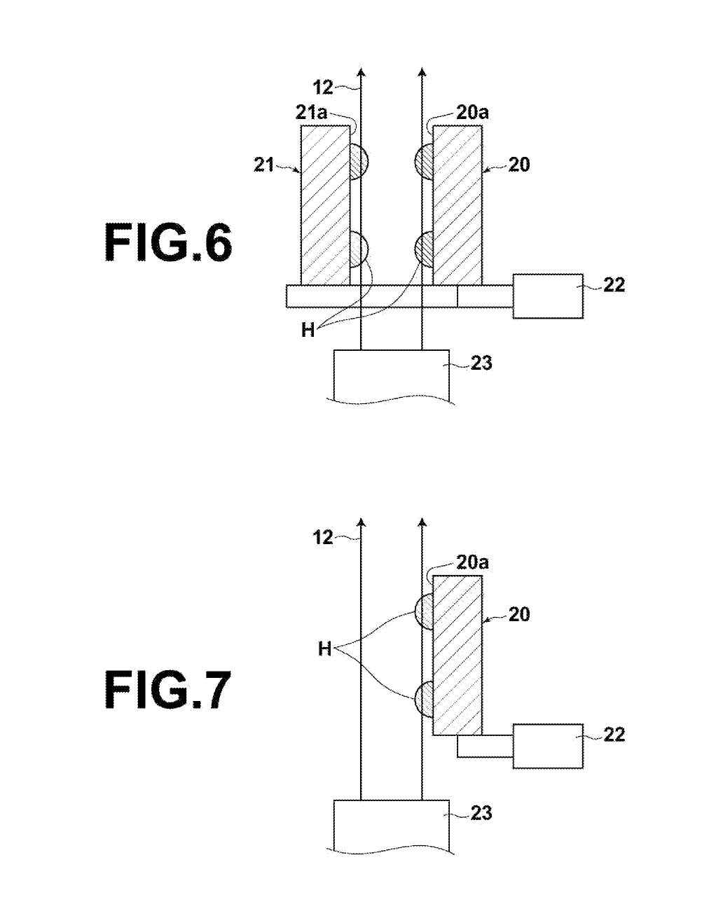

As shown in FIG. 4, the droplets H formed due to dew condensation are held on the dew condensation detection surface lib by the surface tension and do not easily run down on the vertical dew condensation detection surface 11b. Further, in a case where a sufficiently small inner diameter of the dew condensation detection surface 11b is set, the droplets H growing on the dew condensation detection surface 11b merge together before they run down. The merged droplets H are held in the space in the dew condensation detection surface (in the through hole 11a) by the surface tension, and the level of dew condensation can finally reach a state where the space is filled with water and the maximum decrease of the amount of transmitted light is detected. Further, in a case where two opposing plate members 20 and 21 are provided and the inner surfaces of the plate members serve as the dew condensation detection surfaces, as in the structure shown in FIG. 6, which will be described later, a sufficiently small space between the two plate members 20 and 21 may be set to obtain the same effect as that obtained in the case where the sufficiently small inner diameter of the cylindrical dew condensation detection surface lib is set.

It should be noted that the light flux 12 usually has the intensity distribution in the radial direction thereof, and therefore the light flux 12 does not have a clear “edge” that foams a boundary between an area where light is detected and an area where no light is detected. For example, if the light flux 12 is laser light, a dead zone that is suitable for practical use can be set by setting the diameter of the light flux 12 such that the diameter at 1/e² points thereof is positioned almost on the dew condensation detection surface 11b. That is, in this case, a substantial “space” creating the dead zone is set between the edge of the light flux 12 and the dew condensation detection surface 11b.

In the invention, it is not always necessary to use infrared light as the light flux 12, and other types of light, such as visible light, maybe applied as appropriate. However, using infrared light, which is highly absorbable by water, is advantageous in increasing the sensitivity of detection since the occurrence of dew condensation can be detected with a marked decrease of the light detection signal.

Next, a second embodiment of the invention is described with reference to FIG. 6. Among the elements shown in FIG. 6, those that are equivalent to the elements shown in FIGS. 1 to 4 are denoted by the same reference numerals, and the explanation thereof is omitted unless otherwise necessary (the same applies to descriptions of the following embodiments). In descriptions of the following embodiments, only parts including the light flux and the dew condensation detection surface are shown in the drawings and explained. With respect to the other features, those of the first embodiment are basically applicable.

The second embodiment differs from the above-described first embodiment basically in that a pair of plate members 20 and 21 facing each other are provided in place of the temperature control block 11 having the cylindrical clew condensation detection surface 11b, and a light source 23 that emits the light flux 12 having a constant diameter is used. The inner surfaces, i.e., the opposing surfaces, of the pair of plate members 20 and 21 serve as dew condensation detection surfaces 20a and 21a, and the plate members 20 and 21 are disposed such that the light flux 12 travels through the space between the dew condensation detection surfaces 20a and 21a. The plate members 20 and 21 are movable by a moving unit 22 to change the distance between the plate members 20 and 21 in the horizontal direction in the drawing so that the plate members 20 and 21 are brought closer to or further from the center of the light flux 12.

In the case where the pair of plate members 20 and 21 are movable in this manner, the distance between the edge of the light flux 12 and the dew condensation detection surfaces 20a and 21a can be changed, as with the first embodiment where the diameter of the light flux 12 is changed, by changing the distance between the plate members 20 and 21. Therefore, the value of the minimum detectable amount of dew condensation (i.e., the dead zone) can be arbitrarily set.

Next, a third embodiment of the invention is described with reference to FIG. 7. The third embodiment differs from the second embodiment shown in FIG. 6 in that the plate member 21 of the pair of plate members 20 and 21 is omitted. Also in this structure, the plate member 20 is movable by the moving unit 22 in the horizontal direction in the drawing to change the distance between the plate member 20 and the center of the light flux 12. Also in this case, the value of the minimum detectable amount of dew condensation (i.e., the dead zone) can be arbitrarily set by changing the distance between the edge of the light flux 12 and the dew condensation detection surface 20a.

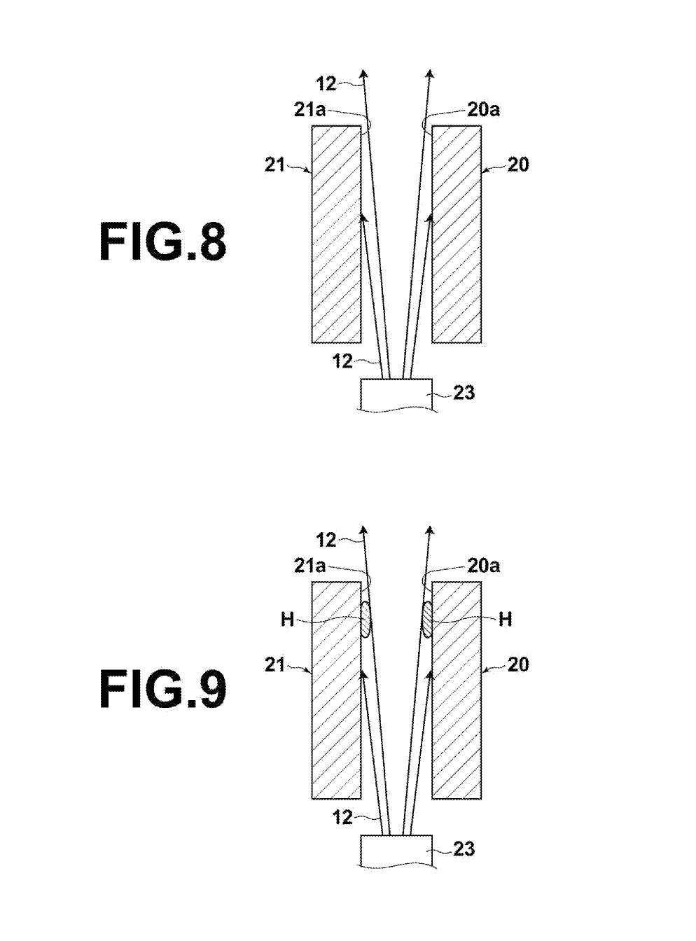

Next, a fourth embodiment of the invention is described with reference to FIGS. 8 and 9. The fourth embodiment differs from the second embodiment shown in FIG. 6 in that a light source, such as a LED (light-emitting diode), that emits the light flux 12 in the form of diverging light having a certain spread angle is used as the light source 23. Also in this structure, the pair of plate members 20 and 21 are movable in the horizontal direction in the drawing to change the distance therebetween, and the same effect as that described above is obtained. The explanation about this point is not repeated here.

The light flux 12 is diverging light, as described above, and the pair of plate members 20 and 21 are disposed parallel to each other. Therefore, as shown in FIGS. 8 and 9, light beams traveling at the edge of the light flux 12 and in the vicinity of the edge impinge on the dew condensation detection surfaces 20a and 21a of the plate members 20 and 21. On the other hand, light beams of the light flux 12 traveling at positions nearer to the center of the light flux, such as the light beams represented by the lines passing through the space between the plate members 20 and 21 shown in FIGS. 8 and 9 and light beams nearer to the center of the light flux than the lines, are not influenced by dew condensation droplets in the state where no dew condensation is occurring, as shown in FIG. 8, and are absorbed or scattered in the state as shown in FIG. 9 where the dew condensation droplets H are deposited on the dew condensation detection surfaces 20a and 21a. Thus, the occurrence of dew condensation and the amount of dew condensation can be detected similarly to the above-described embodiments.

In the case where the above-described LED is used as the light source 23, good results of the dew condensation detection can be obtained by setting the structure such that light beams emitted at a half-value angle from the light source 23 (i.e., light beams having an intensity that is a half the light intensity at the center of the light flux) pass through an area in the vicinity of the dew condensation detection surfaces 20a and 21a.

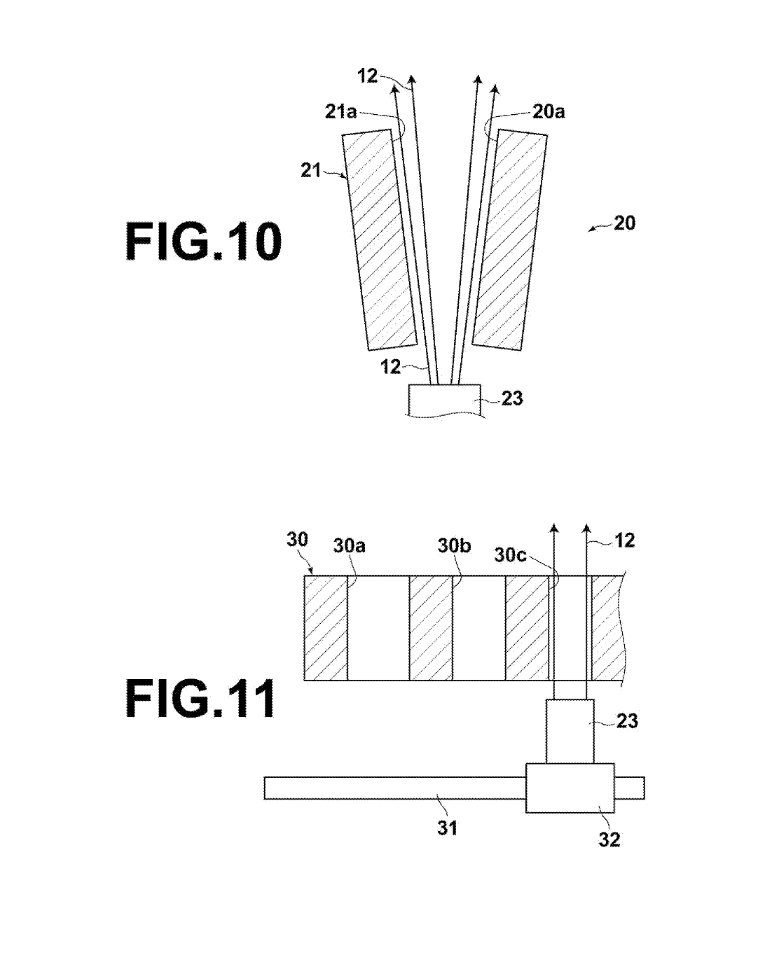

Next, a fifth embodiment of the invention is described with reference to FIG. 10. The fifth embodiment differs from the fourth embodiment shown in FIGS. 8 and 9 in that the pair of plate members 20 and 21 are disposed with being inclined such that the dew condensation detection surfaces 20a and 21a extend along the edge of the light flux 12 in the form of diverging light. In the case where the plate members 20 and 21 are disposed in this manner, light beams traveling at the edge of the light flux 12 and in the vicinity of the edge do not impinge on the dew condensation detection surfaces 20a and 21a, as in the case shown in FIGS. 8 and 9. Thus, the amount of light effectively used for the dew condensation detection is increased, resulting in increased sensitivity of the detection.

Next, a sixth embodiment of the invention is described with reference to FIG. 11. In the sixth embodiment, a block 30 that is similar to the temperature control block 11 shown in FIG. 1, for example, forms a member having a plurality of dew condensation detection surfaces. Namely, the block 30 is provided with a plurality of (three, as one example) through holes having different inner diameters. The inner circumferential walls of the through holes are possibly subject to dew condensation and therefore used as dew condensation detection surfaces 30a, 30b and 30c. The light source 23 that emits the light flux 12 having a constant diameter is mounted on a moving member 32, which moves along a guide member 31 in the form of a rail. The guide member 31 is fixed and extends in a direction along which the three through holes are arranged.

In this structure, the moving member 32 moves along the guide member 31 based on an instruction to move, and stops at one of predetermined stop positions corresponding to the three through holes. Thus, the light flux 12 emitted from the light source 23 travels through one of the three through holes that have the inner circumferential surfaces used as the dew condensation detection surfaces 30a, 30b and 30c. That is, in this state, the edge of the light flux 12 travels along one of the three dew condensation detection surfaces 30a, 30b and 30c.

By selecting one of the three stop positions of the moving member 32, as described above, the distance between the edge of the light flux 12 and the dew condensation detection surface can be arbitrarily changed among three choices of large, middle and small. Then, if it is desired to set the largest value of the minimum detectable amount of dew condensation (i.e., the dead zone) , the stop position where the light flux 12 travels through the through hole having the inner circumferential surface used as the dew condensation detection surface 30a is selected. If it is desired to set the smallest value of the minimum detectable amount, the stop position where the light flux 12 travels through the through hole having the inner circumferential surface used as the dew condensation detection surface 30c is selected. If it is desired to set an intermediate value of the minimum detectable amount, the stop position where the light flux 12 travels through the through hole having the inner circumferential surface used as the dew condensation detection surface 30b is selected.

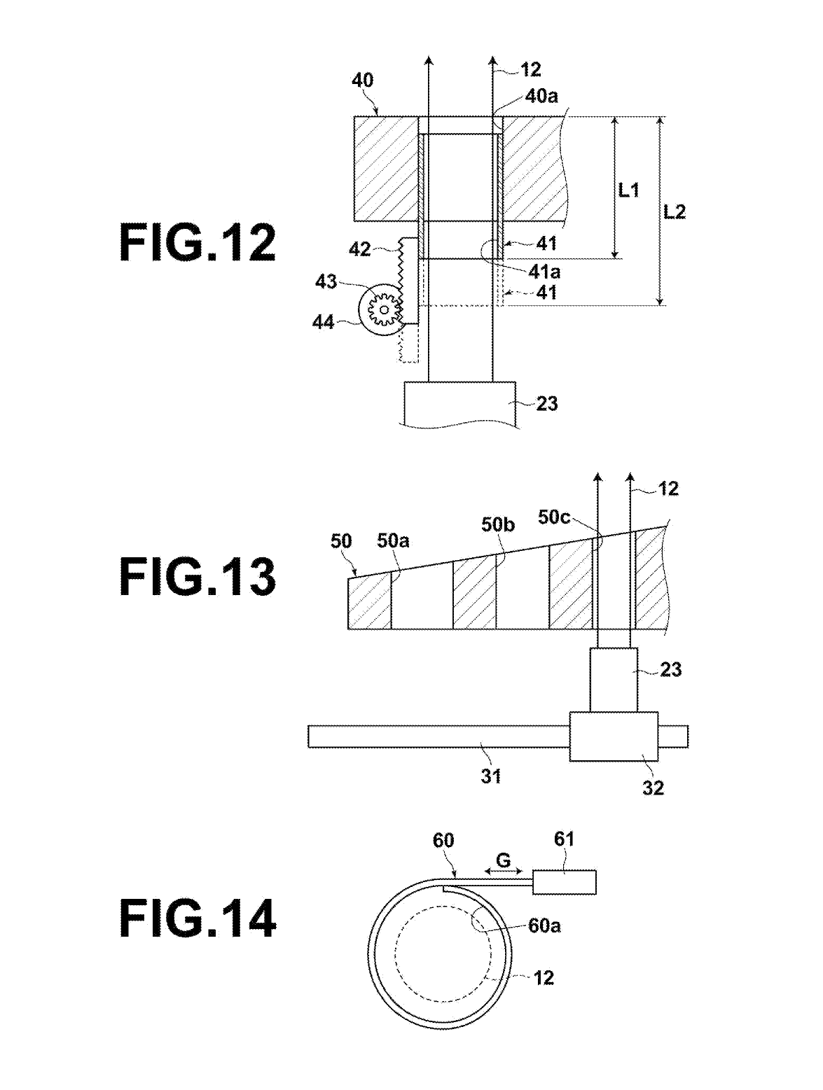

Next, a seventh embodiment of the invention is described with reference to FIG. 12. In the seventh embodiment, a block 40 that is similar to the temperature control block 11 shown in FIG. 1, for example, and a tubular member 41 that is slidable in a through hole formed in the block 40 form a member having a dew condensation detection surface. Namely, the block 40 is provided with a through hole having an inner circumferential surface that is used as a cylindrical dew condensation detection surface 40a, and the tubular member 41 is disposed in the through hole such that the tubular member 41 is slidable in the long axis direction of the through hole (i.e., the thickness direction of the block 40, or the vertical direction in the drawing). The inner circumferential surface of the tubular member 41 is also possibly subject to dew condensation and is used as a dew condensation detection surface 41a.

A rack 42 is connected to the tubular member 41, and a pinion 43 is engaged with the rack 42. The pinion 43 is rotated by a driving unit 44, such as a motor, to move the rack 42 in the vertical direction, and the tubular member 41 can be stopped at a desired position between the highest position shown in the solid line in the drawing and the lowest position shown in the dashed line in the drawing. That is, in this embodiment, the length of the dew condensation detection surface in the traveling direction of the light flux 12 can be arbitrarily changed between the minimum length denoted by L1 in the drawing and the maximum length denoted by L2 in the drawing.

Under the condition where the level of dew condensation on the dew condensation detection surfaces 40a and 41a is the same, the amount of the dew condensation droplets is increased as the length of the dew condensation detection surface is increased, and a more marked decrease of the output signal from the optical detector 15 as shown in FIG. 1 is provided. This allows detecting a change of the level of dew condensation with higher sensitivity. By selecting an appropriate stop position of the tubular member 41 in the vertical direction in this manner, the sensitivity of the dew condensation detection can be arbitrarily changed.

Next, an eighth embodiment of the invention is described with reference to FIG. 13. In the eighth embodiment, a block 50 that is similar to the block 30 shown in FIG. 11 is provided. The block 50 is provided with three through holes having inner circumferential surfaces used as cylindrical dew condensation detection surfaces 50a, 50b and 50c. The dew condensation detection surfaces 50a, 50b and 50c have different inner diameters that decrease in this order. Similarly to the device shown in FIG. 11, the light source 23 is moved by the moving member 32 in the horizontal direction in the drawing and the light flux 12 travels along one of the dew condensation detection surfaces 50a, 50b and 50c.

In this embodiment, the upper surface of the block 50 is inclined so that the dew condensation detection surfaces 50a, 50b and 50c have different lengths in the traveling direction of the light flux. Therefore, in this embodiment, the stop position of the light source 23 in the horizontal direction in the drawing is selected from the three positions, thereby changing the value of the minimum detectable amount of dew condensation similarly to the device shown in FIG. 11 and changing the sensitivity of the dew condensation detection similarly to the device shown in FIG. 12.

It should be noted that, as described above, the structure where the dew condensation detection surfaces 50a, 50b and 50c have different lengths in the traveling direction of the light flux is also applicable to a case where the dew condensation detection surfaces have the same inner diameter. In this case, the sensitivity of the dew condensation detection can be changed by selecting different one of the dew condensation detection surfaces 50a, 50b and 50c along which the edge of the light flux 12 travels.

Next, a ninth embodiment of the invention is described with reference to FIG. 14. FIG. 14 shows a plate member 60, which is a member having a dew condensation detection surface, viewed in the length direction thereof. Namely, the plate member 60 has a predetermined length extending in the direction perpendicular to the plane of the drawing. The plate member 60 is wound to define a cylindrical dew condensation detection surface 60a therein with one end of the plate member 60 shown in the drawing being fixed. A light emitting unit (not shown) is disposed such that the light flux 12 travels along the cylindrical dew condensation detection surface 60a.

The other end of the plate member 60 is contained in the moving unit 61, and a part of the plate member 60 in the vicinity of the other end is moved in the horizontal direction in the drawing by the moving unit 61. When the part in the vicinity of the other end is moved leftward in the drawing to be extended from the moving unit 61, the inner diameter of the cylindrical dew condensation detection surface 60a is increased. On the other hand, when the part in the vicinity of the other end is moved rightward in the drawing to be retracted into the moving unit 61, the inner diameter of the cylindrical dew condensation detection surface 60a is decreased. By changing the inner diameter of the cylindrical dew condensation detection surface 60a in this manner, the distance between the cylindrical dew condensation detection surface 60a and the edge of the light flux 12 is changed, similarly to the case where the diameter of the light flux 12 is changed, thereby allowing arbitrarily adjusting the value of the minimum detectable amount of dew condensation.

The embodiments of the invention where the invention is applied to an analysis device involving temperature control have been described. However, the dew condensation detection device of the invention is applicable not only to the above-described type of analysis devices but also to any types of dew condensation detection, such as dew condensation detection on a wind shield of an automobile, a window glass of a house, etc.

What is claimed is:

1. A dew condensation detection device comprising:
a light emitting unit for emitting a light flux that travels along a dew condensation detection surface of a member having the dew condensation detection surface;
a changing unit for changing a diameter of the light flux; and
an optical detector for receiving the light flux that has passed along the dew condensation detection surface.

2. A dew condensation detection device comprising:
a light emitting unit for emitting a light flux that travels along a dew condensation detection surface of a member having the dew condensation detection surface;
a moving unit for moving the member and the light emitting unit relative to one another to change a distance between the center of the light flux and the dew condensation detection surface; and
an optical detector for receiving the light flux that has passed along the dew condensation detection surface.

3. The dew condensation detection device as claimed in claim 2, wherein the member comprises a pair of members having the dew condensation detection surface, the pair of members being disposed such that the light flux travels through between the dew condensation detection surfaces thereof, and
the moving unit moves the pair of members in a direction in which a distance between the pair of members is changed.

4. The dew condensation detection device as claimed in claim 2, wherein the member comprises a tubular dew condensation detection surface that surrounds the light flux, and the moving unit deforms the member to change the inner diameter of the dew condensation detection surface.

5. The dew condensation detection device as claimed in claim 2, wherein the member comprises a plurality of tubular dew condensation detection surfaces that surround the light flux, the tubular dew condensation detection surfaces having different inner diameters, and
the moving unit moves the member and the light emitting unit relative to one another in a direction along which the dew condensation detection surfaces are arranged so that the light flux selectively travels along one of the dew condensation detection surfaces.

6. The dew condensation detection device as claimed in claim 5, wherein the dew condensation detection surfaces of the member have different lengths in a travel direction of the light flux.

7. The dew condensation detection device as claimed in claim 1, wherein the member is formed such that a length of the dew condensation detection surface in a travel direction of the light flux is changeable.

8. The dew condensation detection device as claimed in claim 2, wherein the member is formed such that a length of the dew condensation detection surface in a travel direction of the light flux is changeable.

9. A dew condensation detection method comprising:
letting a light flux to travel along a dew condensation detection surface of a member having the dew condensation detection surface, wherein a diameter of the light flux is changeable;
detecting an amount of light of the light flux that has passed along the dew condensation detection surface; and
detecting a state of dew condensation on the dew condensation detection surface based on the detected amount of light.

10. A dew condensation detection method comprising:
letting a light flux to travel along a dew condensation detection surface of a member having the dew condensation detection surface, wherein the member and a light emitting unit are movable relative to one another to change a distance between the center of the light flux and the dew condensation detection surface;
detecting an amount of light of the light flux that has passed along the dew condensation detection surface; and
detecting a state of dew condensation on the dew condensation detection surface based on the detected amount of light.
